(19) United States
(12) Patent Application Publication
(10) Pub. No.: US 2013/0206283 A1
(43) Pub. Date: Aug. 15, 2013

(54) GRAIN ORIENTED ELECTRICAL STEEL SHEET AND METHOD FOR MANUFACTURING THE SAME

(71) Applicants: Hirotaka Inoue, Tokyo (JP); Hiroi Yamaguchi, Tokyo (JP); Seiji Okabe, Tokyo (JP); Takeshi Omura, Tokyo (JP)

(72) Inventors: Hirotaka Inoue, Tokyo (JP); Hiroi Yamaguchi, Tokyo (JP); Seiji Okabe, Tokyo (JP); Takeshi Omura, Tokyo (JP)

(73) Assignee: JFE STEEL CORPORATION, Tokyo (JP)

(21) Appl. No.: 13/814,115

(22) PCT Filed: Aug. 5, 2011
(86) PCT No.: PCT/JP2011/004477

§ 371 Date: Feb. 13, 2013

(30) Foreign Application Priority Data
Aug. 6, 2010 (JP) 2010-178136

(51) Int. Cl. H01F 1/01; H01F 41/02

(52) U.S. Cl. CPC H01F 1/01; H01F 41/02
USPC 148/108; 148/306

(57) ABSTRACT

A grain oriented electrical steel sheet has thermal strain introduced thereinto in a dotted-line arrangement in which strain-imparted areas are lined in a direction that crosses a rolling direction of the steel sheet, wherein the strain-imparted areas introduced in the dotted-line arrangement have a size from 0.10 mm or more to 0.50 mm or less and an interval between the adjacent strain-imparted areas is from 0.10 mm or more to 0.60 mm or less.

### RELATED APPLICATIONS

This is a §371 of International Application No. PCT/JP2011/004477, with an international filing date of Aug. 5, 2011 (WO 2012/017693 A1, published Feb. 9, 2012), which is based on Japanese Patent Application No. 2010-178136, filed Aug. 6, 2010, the subject matter of which is incorporated herein by reference.

### TECHNICAL FIELD

This disclosure relates to a grain oriented electrical steel sheet advantageously utilized for an iron core of a transformer and the like and a method for manufacturing a grain oriented electrical steel sheet advantageously utilized for an iron core of a transformer and the like.

### BACKGROUND

A grain oriented electrical steel sheet is mainly utilized as an iron core of a transformer and required to exhibit superior magnetization characteristics, e.g. low iron loss in particular. In this regard, it is important to highly accumulate secondary recrystallized grains of a steel sheet in (110)[001] orientation, i.e., what is called “Goss orientation,” and reduce impurities in a product steel sheet. However, there are restrictions on controlling crystal grain orientations and reducing impurities in view of production cost. Accordingly, there has been developed a technique of introducing non-uniformity into a surface of a steel sheet by physical means to subdivide the width of a magnetic domain to reduce iron loss, i.e., magnetic domain refinement technique.

For example, JP-B 57-002252 proposes a technique of irradiating a steel sheet as a finished product with a laser to introduce high-dislocation density regions into a surface layer of the steel sheet, thereby narrowing magnetic domain widths and reducing iron loss of the steel sheet. JP-B 06-072266 suggests a technology for controlling magnetic domain widths by irradiating an electron beam.

However, in the case where a grain oriented electrical steel sheet with reduced iron loss obtained by conducting above-mentioned magnetic domain refinement technique including irradiation with a laser or an electron beam is adapted to an actual transformer, there was a problem in which the iron loss property of the actual transformer was not improved even if the iron loss of the material (steel sheet) was thus reduced. That is, a building factor (BF) became poor, in such case.

Therefore, it could be helpful to provide a grain oriented electrical steel sheet capable of reducing iron loss even in the case where the grain oriented electrical steel sheet is stacked and adapted to an iron core of a transformer or the like by conducting magnetic domain refinement treatment.

### SUMMARY

We thus provide:
(1) A grain oriented electrical steel sheet having thermal strain introduced thereinto in a dotted-line arrangement in which strain-imparted areas have been lined in a direction that crosses the rolling direction of the steel sheet, wherein the strain-imparted areas introduced in the dotted-line arrangement have a size from 0.10 mm or more to 0.50 mm or less and an interval between the adjacent strain-imparted areas is from 0.10 mm or more to 0.60 mm or less.
(2) The grain oriented electrical steel sheet of (1) above, wherein a line interval between the dotted-lines in the rolling direction is from 2 mm to 10 mm.
(3) A method for manufacturing a grain oriented electrical steel sheet, comprising:
   introducing thermal strain into a grain oriented electrical steel sheet in a dotted-line arrangement in which strain-imparted areas have been lined in a direction that crosses the rolling direction of the steel sheet by irradiating an electron beam, wherein a line interval between the electron beam irradiation in the rolling direction is from 2 mm to 10 mm, an irradiated dot interval in the dotted-line arrangement is from 0.2 mm or more to 1.0 nun or less, and an irradiation energy amount E per unit beam diameter defined by Formula (1) is 30 mJ/mm or more and 180 mJ/mm or less, wherein:

E=[Acceleration voltage of electron beam (kV)×Beam current value (mA)×Irradiation period per one dot (μs)/1,000]/Beam diameter (mm) (1).
(4) A method for manufacturing a grain oriented electrical steel sheet, comprising:
   introducing a thermal strain into a grain oriented electrical steel sheet in a dotted-line arrangement in which strain-imparted areas have been lined in a direction that crosses the rolling direction of the steel sheet by continuously irradiating a laser beam, wherein a line interval between the continuous laser irradiation in the rolling direction is from 2 mm to 10 mm, an irradiated dot interval in the dotted-line arrangement is from 0.2 mm or more to 1.0 mm or less, and an irradiation energy amount E per unit beam diameter defined by Formula (2) is 40 mJ/mm or more and 200 mJ/mm or less, wherein:

E=[Average laser power (W)×Irradiation period per one dot (μs)/1,000]/Beam diameter (mm) (2).

It is possible to reduce iron losses in both the rolling direction and the direction orthogonal to the rolling direction by imparting strain in a dotted-line arrangement under restrictions. Thus, it is possible to further reduce iron loss in a transformer provided with stacked grain oriented electrical sheets obtained as above.

### BRIEF DESCRIPTION OF THE DRAWINGS

Our steel sheets and methods will be further described below with reference to the accompanying drawings, wherein:

FIG. 1 is a graph showing relationships between the interval between the adjacent strain-imparted areas and iron loss;

FIG. 2 is a graph showing relationships between the interval between the adjacent strain-imparted areas and iron loss;

FIG. 3 is a graph showing relationships between the size of strain-imparted area and iron loss;

FIG. 4 is a graph showing relationships between the size of strain-imparted area and iron loss; and

FIG. 5 is a diagram illustrating a shape of the transformer iron core.

### DETAILED DESCRIPTION

To reduce iron loss of a grain oriented electrical steel sheet utilized as an iron core of a transformer, that is, to reduce an iron loss of the transformer itself, the iron loss in a direction other than the rolling direction as well as the iron loss in a rolling direction of the steel sheet needs to be reduced.

Regarding the magnetized status in the transformer during excitation, a phenomenon “magnetization rotation” is known to occur. In magnetization rotation, the magnetization direction is oriented to a direction other than the rolling direction when magnetic excitation is provided in a direction parallel to the rolling direction. In the case where a transformer with a three-phase and three-leg iron core is excited at magnetic flux density of 1.7 T in a direction parallel to the rolling direction, for example, we found that magnetic flux of 0.1 T to 1.0 T is at least locally oriented along the direction orthogonal to the rolling direction. When the magnetization direction is oriented to a direction other than the rolling direction in a grain oriented electrical steel sheet, the magnetization direction is eventually directed to the direction having low magnetic permeability and whereby the iron loss is increased. Such increase in iron loss caused by magnetization rotation is a cause for generating transformer iron loss larger than iron loss of the material itself (iron loss in the rolling direction).

An index for expressing deterioration in magnetic property is called BF (Building Factor), the value obtained from dividing the value of iron loss at a transformer by a value of iron loss at the material under the same magnetization condition. It is important to reduce iron loss in a direction other than the rolling direction, especially in a direction orthogonal to the rolling direction to reduce the value of BF.

Therefore, we introduced strain-imparted thermal areas having appropriate sizes in a dotted line pattern with appropriate intervals between the adjacent strain-imparted areas. We also found that both iron loss values in the rolling direction and the direction orthogonal to the rolling direction are reduced and a grain oriented electrical steel sheet exhibiting smaller value of transformer iron loss is eventually obtained.

The principle for reduction in iron loss caused by strain imparting is set forth below. That is, when strain is imparted into a steel sheet, tension is introduced in a direction of the dotted-line to generate a closure domain originated from the strain. On one hand, generation of the closure domain increases magnetostatic energy and, on the other hand, the 180° magnetic domain is subdivided to reduce the increased magnetostatic energy. Accordingly, the iron loss in the rolling direction is reduced. In the case where the larger amount of strain is imparted and the more closure domain is generated, the 180° magnetic domains is further subdivided and the iron loss in the rolling direction is further reduced. The increased tension in a direction of the dotted line causes a larger value of magnetic permeability in a direction orthogonal to the rolling direction by inverse magnetostriction effect and the iron loss in the direction orthogonal to the rolling direction is eventually reduced.

Regarding the iron loss in the rolling direction, eddy current loss is reduced by narrowing the widths of magnetic domains by increasing the amount of strain to a level over or equal to an appropriate level, while a hysteresis loss increases and the iron loss in the rolling direction gets larger totally. In the case where density of strain-imparted areas in a steel sheet is high, the hysteresis loss in the rolling direction and the direction orthogonal to the rolling direction is increased since the strain-imparted areas inhibit magnetic flow.

Based on the above, when an appropriate amount of strain is imparted into the steel sheet at an appropriate density of strain-imparted areas, iron losses in both rolling direction and the direction orthogonal to the rolling direction can be reduced so that a grain oriented electrical steel sheet exhibiting lower transformer iron loss can be manufactured.

Next, to determine the appropriate condition for strain-imparting, an electron beam is irradiated according to variety of irradiation conditions and the size of strain-imparted regions and the intervals between the adjacent strain-imparted regions in each steel sheet are investigated. The measurement methods for the size of strain-imparted regions and the intervals will be described later. The changes in values of W_{17/50} in the rolling direction and the values of W_{2/50} in the direction orthogonal to the rolling direction before or after the irradiation were studied. The excitation level for the direction orthogonal to the rolling direction is determined by using the iron loss value for 0.2 T as an index. Such value corresponds to an average value for a component of magnetic flux density in the direction orthogonal to the rolling direction, in a transformer for which we conducted the research.

In an experiment, an electron beam having an acceleration voltage of 40 kV and beam current value of 2.5 mA was irradiated in a direction orthogonal to the rolling direction continuously or in a dotted line pattern having interval of 7 mm between irradiated lines according to the condition shown in Table 1. The continuous irradiation was conducted at a beam scanning rate of 4 m/s, while the dotted line irradiation was conducted at a beam scanning rate of 50 m/s with 100 μs intermissions between predetermined time intervals which determine lengths of the space between irradiated dots. Samples subjected to the experiment were grain oriented electrical steel sheets having a thickness of 0.23 mm and having B₈ value before irradiation of approximately 1.93 T.

Definitions and measurement methods for the above-mentioned size of strain-imparted areas and the intervals between the adjacent strain-imparted areas are set forth below.

### Size of Strain-Imparted Areas

A surface coating of a steel sheet after subjected to final annealing was removed by acid or alkali and, then, the hardness measurement was conducted by using nanoindenter for the strain-imparted areas. The hardness at the position at least 1 mm away from strain-imparted line was used as a standard and the areas of hardness that is higher than the hardness at the position by 10% or more were defined as strain-imparted areas (i.e., strain-imparted areas distributed in a dotted line).

The maximum length in the direction orthogonal to the rolling direction within the strain-imparted area was defined as the size of strain-imparted area. In the continuous irradiation condition or in the condition where the strain-imparted areas corresponding to the neighboring dotted lines overlap each other, the maximum length in the rolling direction was defined as the size of strain-imparted area. The size of strain-imparted area was measured based on the above definitions. Specifically, the size of strain-imparted area was determined, for example, as the average value calculated based on each ten strain-imparted points, in the center portion of sample steel sheet, selected from three different dotted lines per one sheet.

### Intervals Between Adjacent Strain-Imparted Areas

Between the above-defined strain-imparted areas, the minimum length free from the both effects of the adjacent strain-imparted areas was defined as the interval between the adjacent strain-imparted areas. In the continuous irradiation condition or in the condition where the strain-imparted areas corresponding to the neighboring dotted lines overlap each other, the interval between the adjacent strain-imparted areas was defined as 0 mm. On the basis of the above definitions, the interval between the adjacent areas was measured. The interval between the adjacent areas was determined, for example, as the average value calculated based on each ten strain-imparted points, in the center portion of sample steel sheet, selected from three different dotted lines per one sheet.

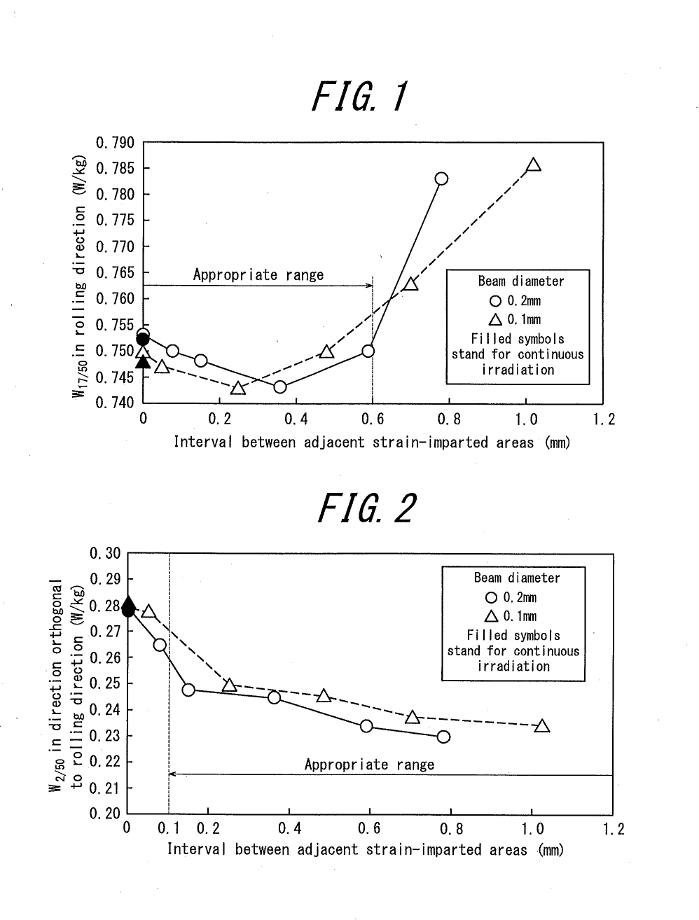

Table 1 shows the result of the study for the size of strain-imparted area and interval between the adjacent strain-imparted areas in each steel sheet in various irradiation conditions and in various intervals between irradiated dots in the direction orthogonal to the rolling direction. FIGS. 1 and 2 show the change in values of W_{17/50} and W_{2/50} in the rolling direction as a function of the interval between the adjacent strain-imparted areas.

TABLE 1

| | | Irradiation | | | Dot interval |
|---|---|---|---|---|---|
| | | interval | | | between |
| | | in direction | | | adjacent |
| | | orthogonal | | Size of | strain- |
| | | to rolling | Beam | strain- | imparted |
| Con- | | direction | diameter | imparted | areas |
| dition | Irradiation | (mm) | (mm) | area (mm) | (mm) |
| 1 | Continuous | — | 0.2 | 0.27 | No interval |
| 2 | Dotted line | 1.2 | 0.2 | 0.28 | 0.78 |
| 3 | Dotted line | 0.9 | 0.2 | 0.28 | 0.59 |
| 4 | Dotted line | 0.7 | 0.2 | 0.29 | 0.36 |
| 5 | Dotted line | 0.5 | 0.2 | 0.29 | 0.15 |
| 6 | Dotted line | 0.4 | 0.2 | 0.29 | 0.08 |
| 7 | Dotted line | 0.3 | 0.2 | 0.32 | No interval |
| 8 | Continuous | — | 0.1 | 0.16 | No interval |
| 9 | Dotted line | 1.2 | 0.1 | 0.17 | 1.02 |
| 10 | Dotted line | 0.9 | 0.1 | 0.17 | 0.7 |
| 11 | Dotted line | 0.7 | 0.1 | 0.18 | 0.48 |
| 12 | Dotted line | 0.5 | 0.1 | 0.18 | 0.25 |
| 13 | Dotted line | 0.3 | 0.1 | 0.19 | 0.05 |
| 14 | Dotted line | 0.2 | 0.1 | 0.21 | No interval |

As Shown in FIG. 1, in the case where the interval between the adjacent strain-imparted areas was 0.60 mm or less, the value of W_{17/50} in the rolling direction corresponded to smaller value. The value of iron loss was smaller since the narrower intervals between the adjacent strain-imparted areas resulted in the larger amount of stain imparted which caused magnetic domain refining effect.

On the other hand, as shown in FIG. 2, the value of iron loss W_{2/50} in the direction orthogonal to the rolling direction decreased by 10% or more from the values for continuous irradiation, when the dotted line irradiation was conducted under a condition in which the interval between the adjacent strain-imparted areas, was at least 0.10 mm. This phenomenon occurred presumably because the increase in hysteresis loss in the direction orthogonal to the rolling direction was suppressed by minimizing the dimension of strain-imparted areas.

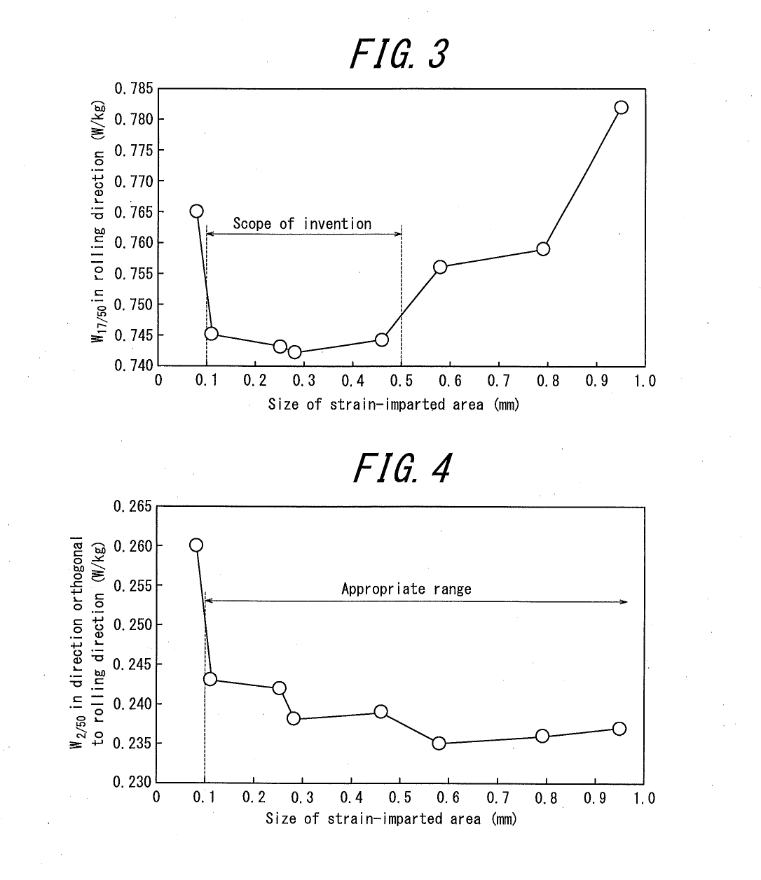

Next, we studied effects of the size of the strain-imparted areas. An electron beam at an acceleration voltage of 40 kV was irradiated in a dotted-line in a direction orthogonal to the rolling direction of the steel sheet with spacing of 7 mm in the rolling direction. The irradiation was conducted under a condition in which the beam diameter and the current density were adjusted so that interval between the adjacent strain-imparted areas ranged from 0.2 mm or more to 0.3 mm or less and the respective strain-imparted areas had different sizes. FIG. 3 shows the relation between the size of stain-imparted area and the value of iron loss. In the case where the size of stain-imparted area is between 0.1 mm or more and 0.5 mm or less, the value for W_{17/50} in the rolling direction got smaller. This phenomenon occurred presumably because the larger sizes of strain-imparted areas increased the amount of stain imparted to exert magnetic domain refining effect for reducing the iron loss. Once the strain larger than a certain amount was imparted, the hysteresis loss in the rolling direction was larger and iron loss accompanied it. As shown in FIG. 4, the value of iron loss W_{2/50} in the direction orthogonal to the rolling direction was smaller when the size of stain-imparted area is 0.1 mm or more. This phenomenon occurred presumably because closure magnetic domain capable of decreasing iron loss in the direction orthogonal to the rolling direction could not develop sufficiently when the size of strain-imparted area was less than 0.1 mm.

Based on such experimental results, we found that both values of iron losses in the rolling direction and the direction orthogonal to the rolling direction decreased when strain was imparted in a dotted-line for obtaining the appropriate size of strain-imparted areas and the interval between the adjacent strain-imparted areas. Accordingly, we obtained a grain oriented electrical steel sheet having low transformer iron loss.

As mentioned above, it is necessary to reduce iron losses in both the rolling direction and the direction orthogonal to the rolling direction to reduce iron loss in a transformer. On one hand, it is important to form thermal strain-imparted areas under a condition capable of satisfying the size of strain-imparted area of 0.10 mm or more and 0.50 mm or less and the interval of the adjacent strain-imparted areas of 0.60 mm or less to reduce iron loss in the rolling direction. On the other hand, it is important to form thermal strain-imparted areas under a condition capable of satisfying the size of strain-imparted area of 0.10 mm or more and the interval between the adjacent strain-imparted areas of 0.10 mm or more to reduce iron loss in the direction orthogonal to the rolling direction.

Further, the line interval in the rolling direction between the strains imparted in dotted-line arrangement is preferably set 2 mm or more and 10 mm or less. In the case where the line interval is less than 2 mm, the amount of strains imparted into the steel sheet is too much and hysteresis loss increases significantly in the rolling direction. On the other hand, in the case where the line interval exceeds 10 mm, the magnetic domain refining effect is reduced, whereby iron loss in both rolling direction and the direction orthogonal to the rolling direction increase.

Further, strains imparted in a dotted-line arrangement in a direction that crosses the rolling direction of a steel sheet is disposed for having an angle within 30° between the dotted line and the direction orthogonal to the rolling direction. In the case where the tilting angle against the direction orthogonal to the rolling direction exceeds such a range, the decrease of iron loss in the rolling direction is suppressed even though the iron loss in the direction orthogonal to the rolling direction decreases, and eventually the decrease in iron loss for a transformer is suppressed. More preferably, the strains are imparted along the direction orthogonal to the rolling direction.

By satisfying the above mentioned condition, an appropriate amount of strain is imparted into a steel sheet to generate closure magnetic domains so that iron loss in both the rolling direction and the direction orthogonal to the rolling direction decreased sufficiently, and eventually a grain oriented electrical steel sheet, optimal for the reduction in iron loss in a transformer is obtained. Outside of such an appropriate range, in the case where the amount of strain imparted is insufficient, the effect of reducing iron loss is suppressed, and in the case where the amount of stain imparted is too much or the stain-imparted area is too large, the hysteresis loss significantly increases and the effect of reducing iron loss is suppressed.

Next, the manufacturing method for imparting thermal strains under the above mentioned condition will be set forth below.

First, as an introduction method for dotted-line strains, it is suitable to utilize an electron beam irradiation or a continuous laser irradiation capable of introducing huge energy by a focused beam diameter. As another magnetic domain refining method, plasma-jet irradiation is known even though it is difficult to adapt such means to our methods.

### (i) Introduction of Thermal Strains by Electron Beam Irradiation

Irradiation condition was studied for introducing the above defined thermal strains by conducting experiments for electron beams of different intervals between dotted-lines and irradiation energy amount E. The irradiation energy amount E is defined by the formula below:

E (mJ/mm)=[Acceleration voltage of electron beam (kV)×Beam current value (mA)×Irradiation period per one dot (μs)/1,000]/Beam diameter (mm).

The beam diameter is determined by a known slit method using a half width of energy profile.

As a result of the above study, we found that the above identified condition of introducing strains is satisfied in the case where the line interval in the rolling direction for the electron beam irradiation is from 2 mm to 10 mm; an irradiated dot interval in the dotted-line arrangement is from 0.2 mm or more to 1.0 mm or less; and an irradiation energy amount E per unit beam diameter is 30 mJ/mm or more and 180 mJ/mm or less.

### (ii) Introduction of Thermal Strains by Means of Continuous Laser Irradiation

Irradiation condition was studied for continuous laser irradiation in the range satisfying the above condition in the same manner. The irradiation energy amount E is defined by the formula below:

E (mJ/mm)=[Average laser power (W)×Irradiation period per one dot (μs)/1,000]/Beam diameter (mm).

As a result of the above study, it has been revealed that the above identified condition of introducing strains is satisfied in the case where the line interval in the rolling direction for the irradiation of laser is 2 mm to 10 mm; an irradiated dot interval in the dotted-line arrangement is from 0.2 mm or more to 1.0 mm or less; and an irradiation energy amount E per unit beam diameter is 40 mJ/mm or more and 200 mJ/mm or less.

The laser oscillation can be switched off or switched to low power when a laser beam moves between irradiation dots. The beam diameter can be set uniquely based on a collimator and the focal length of a lens in an optical system.

The method of introducing strains in the dotted-line arrangement is realized by repeating a process in which an electron beam or a laser beam rapidly scans across a steel sheet while the scan is stopped at every dot for a given time period, the irradiation continues at the dot, and then the scan restarts. Such process can be realized by an electron beam irradiation in which a diffraction voltage of the electron beam is varied by using an amplifier having a large capacity.

When a steel sheet is subjected to strain introduction in the dotted-line arrangement by an electron beam or a continuous laser beam, the resultant steel sheet has irradiation traces and an electrical insulation property of the steel sheet may be compromised. In such a case, recoating of the insulating coating is conducted and the coating thus applied is baked at a temperature range in which the introduced strain is not compensated.

Next, a manufacturing condition for a grain oriented electrical steel sheet other than the above-identified condition will be concretely explained. It is preferable to have a magnetic flux density B₈ of 1.90 T or more, which can be an indicator of degrees of accumulation, since the higher degrees of accumulation in <100> direction among crystal grains leads to the higher iron loss reduction effect caused by magnetic domain refining.

The chemical composition of a slab for the grain oriented electrical steel sheet may be any chemical composition as long as the composition can cause secondary recrystallization. Further, in a case of using an inhibitor, for example, such as using AlN inhibitor, an appropriate amount of Al and N may be contained while in a case of using an MnS and/or MnSe inhibitor, an appropriate amount of Mn and Se and/or S may be contained. It is needless to say that both of the inhibitors may also be used in combination. Preferred contents of Al, N, S, and Se in this case are as follows: Al: 0.01 mass % to 0.065 mass %; N: 0.005 mass % to 0.012 mass %; S: 0.005 mass % to 0.03 mass %; and Se: 0.005 mass % to 0.03 mass %.

Further, our methods can also be applied to a grain oriented electrical steel sheet in which the contents of Al, N, S, and Se are limited and no inhibitor is used. In that case, the amounts of Al, N, S, and Se each may preferably be suppressed as follows: Al: 100 mass ppm or below; N: 50 mass ppm or below; S: 50 mass ppm or below; and Se: 50 mass ppm or below.

Specific examples of basic components and other components to be optionally added to a steel slab for use in manufacturing the grain oriented electrical steel sheet are as follows.

### C: 0.08 Mass % or Less

Carbon is added to improve texture of a hot rolled steel sheet. Carbon content in steel is preferably 0.08 mass % or less because carbon content exceeding 0.08 mass % increases the burden of reducing carbon content during the manufacturing process to 50 mass ppm or less at which magnetic aging is reliably prevented. The lower limit of carbon content in steel need not be particularly set because secondary recrystallization is possible in a material not containing carbon.

### Si: 2.0 Mass % to 8.0 Mass %

Silicon is an element which effectively increases electrical resistance of steel to improve iron loss properties thereof. Silicon content in steel equal to or higher than 2.0 mass % ensures a particularly good effect of reducing iron loss. On the other hand, Si content in steel equal to or lower than 8.0 mass % ensures particularly good formability and magnetic flux density of a resulting steel sheet. Accordingly, Si content in steel is preferably 2.0 mass % to 8.0 mass %.

### Mn: 0.005 Mass % to 1.0 Mass %

Manganese is an element which advantageously achieves good hot-workability of a steel sheet. Manganese content in a steel sheet less than 0.005 mass % cannot cause the good effect of Mn addition sufficiently. Manganese content in a steel sheet equal to or lower than 1.0 mass % ensures particularly good magnetic flux density of a product steel sheet. Accordingly, Mn content in a steel sheet is preferably 0.005 mass % to 1.0 mass %.

Further, the steel slab for the grain oriented electrical steel sheet may contain, for example, the following elements as magnetic properties improving components in addition to the basic components described above.
At least one element selected from Ni: 0.03 mass % to 1.50 mass %, Sn: 0.01 mass % to 1.50 mass %, Sb: 0.005 mass % to 1.50 mass %, Cu: 0.03 mass % to 3.0 mass %, P: 0.03 mass % to 0.50 mass %, Mo: 0.005 mass % to 0.10 mass %, and Cr: 0.03 mass % to 1.50 mass %

Nickel is a useful element in terms of further improving texture of a hot rolled steel sheet and thus magnetic properties of a resulting steel sheet. However, Nickel content in steel less than 0.03 mass % cannot cause this magnetic properties-improving effect by Ni sufficiently, while Nickel content in steel equal to or lower than 1.5 mass % ensures stability in secondary recrystallization to improve magnetic properties of a resulting steel sheet. Accordingly, Ni content in steel is preferably 0.03 mass % to 1.5 mass %.

Sn, Sb, Cu, P, Cr, and Mo each are a useful element in terms of improving magnetic properties of the grain oriented electrical steel sheet. However, sufficient improvement in magnetic properties cannot be obtained when the contents of these elements are less than the respective lower limits specified above. On the other hand, contents of these elements equal to or lower than the respective upper limits described above ensure the optimum growth of secondary recrystallized grains. Accordingly, it is preferred that the steel slab for grain oriented electrical steel sheet contains at least one of Sn, Sb, Cu, P, Cr, and Mo within the respective ranges thereof specified above.

The balance other than the aforementioned components of the grain oriented electrical steel sheet is Fe and incidental impurities incidentally mixed thereinto during the manufacturing process.

Next, the slab having the aforementioned chemical compositions is heated and then subjected to hot rolling according to a conventional method. Alternatively, the casted slab may be immediately hot rolled without being heated. In a case of a thin cast slab/strip, the slab/strip may be either hot rolled or directly fed to the next process skipping hot rolling.

A hot rolled steel sheet (or the thin cast slab/strip which skipped hot rolling) is then subjected to hot-band annealing according to necessity. The main purpose of the hot-band annealing is to eliminate the band texture resulting from the hot rolling to have the primary recrystallized texture formed of uniformly-sized grains so that the Goss texture is allowed to further develop in the secondary recrystallization annealing, to thereby improve the magnetic property. At this time, to allow the Goss texture to highly develop in the product steel sheet, the hot-band annealing temperature is preferably 800° C. to 1,100° C. At a hot-band annealing temperature lower than 800° C., the band texture resulting from the hot rolling is retained which makes it difficult to have the primary recrystallization texture formed of uniformly-sized grain and, thus, a desired improvement in secondary recrystallization cannot be obtained. On the other hand, at a hot-band annealing temperature higher than 1,100° C., the grain size is excessively coarsened after the hot-band annealing which makes it extremely difficult to obtain a primary recrystallized texture formed of uniformly-sized grain.

After the hot-band annealing, the steel sheet is subjected to cold rolling at least once or at least twice, with intermediate annealing therebetween before being subjected to decarburizing annealing (which also serves as recrystallization annealing), which is then applied with an annealing separator. The steel sheet applied with an annealing separator is then subjected to final annealing for the purpose of secondary recrystallization and forming a forsterite film (film mainly composed of Mg₂SiO₄).

To form forsterite, an annealing separator mainly composed of MgO may preferably be used. A separator mainly composed of MgO may also contain, in addition to MgO, a known annealing separator component or a property improvement component without inhibiting formation of an intended forsterite film.

After the final annealing, it is effective to level the shape of the steel sheet through flattening annealing. Meanwhile, the steel sheet surface is applied with a insulating coating before or after the flattening annealing. The insulating coating refers to a coating capable of imparting tension to a steel sheet for the purpose of reducing iron loss (referred to as tension-imparting coating, hereinafter). The tension-imparting coating can be implemented by, for example, an inorganic coating containing silica or a ceramic coating applied by physical deposition, chemical deposition and the like.

Magnetic refinement is implemented by irradiating the surface of a grain oriented electrical steel sheet with an electron beam or a continuous laser beam under the above-described condition after the final annealing or after the tension-imparting coating.

Processes or conditions other than the above described processes or manufacturing condition, the conventionally known manufacturing method for grain oriented electrical steel sheets including magnetic refinement processing using an electron beam or a continuous laser beam can be adapted.

### EXAMPLES

A cold rolled sheet including Si at 3 mass % and having final sheet thickness of 0.23 mm was subjected to decarburizing and annealing for primary recrystallization; annealing separator mainly composed of MgO was applied to the steel sheet; and the steel sheet was subjected to final annealing including secondary recrystallization process and purification process, whereby a grain oriented electrical steel sheet having a forsterite film is obtained. Then, the steel sheet was applied with an insulating coating containing colloidal silica by 60 mass % and aluminum phosphate and the steel sheet was baked at 800° C. Then, the steel sheet was irradiated with an electron beam or laser beam in a direction orthogonal to the rolling direction such that introducing strains into the steel sheet in dotted-line arrangement or continuous line arrangement. In dotted line irradiation, the interval between the direction orthogonal to the rolling direction was varied by controlling the stop time period in beam scanning. Accordingly, a steel material having magnetic flux density B₈ in the range of 1.90 T to 1.94 T was obtained.

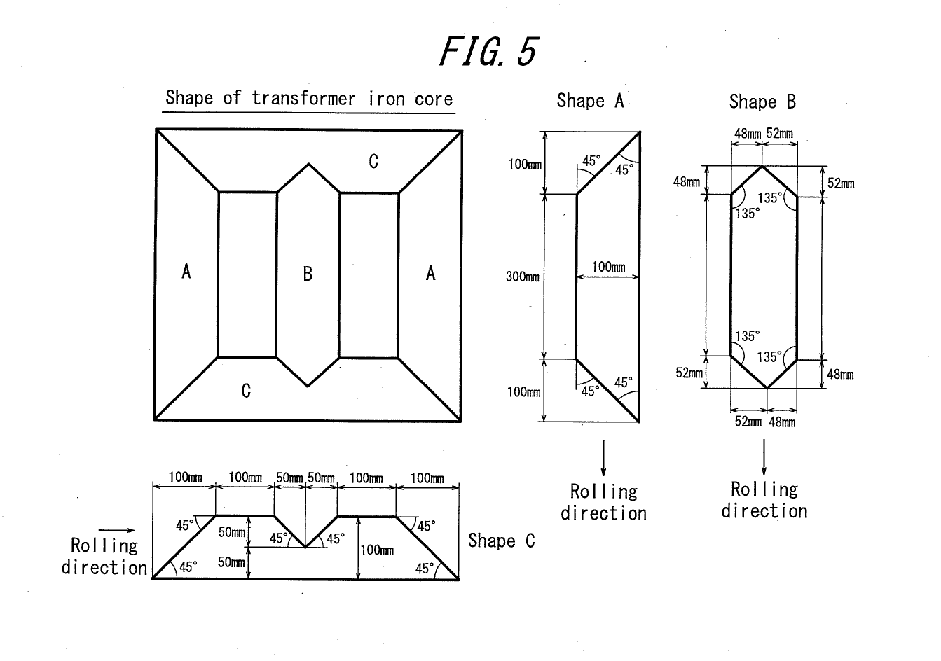

The steel material thus obtained was sheared into specimens, having bevel edges, with shape and dimension as shown in FIG. 5 and stacked alternately in 70 layers such that assembling a three-phase and three-leg type transformer iron core of 500 mm square. The transformer was excited at magnetic flux density of 1.7 T and excitation frequency of 50 Hz and non-load loss (i.e., transformer iron loss) was measured by a power meter.

The measured values for transformer iron loss are shown in Tables 2 and 3 together with parameters including irradiation condition, size of strain-imparted area, and interval between the adjacent strain-imparted areas.

TABLE 2

| | | | | | | | | | Strain-imparted area | | | | |
|---|---|---|---|---|---|---|---|---|---|---|---|---|---|
| | | Irradiation condition | | | | | | | | Interval | | | |
| | | | | | | Irradi- | | | | between | | Iron | |
| | | | | | | ation | | | Size of | adjacent | | loss of | |
| | | | | Acceler- | Beam | period | Beam | | strain- | strain- | | trans- | |
| | | Line | Dot | ation | current | per | diam- | E | imparted | imparted | | former | |
| Condi- | | interval | interval | voltage | value | one dot | eter | (mJ/ | area | areas | | W_{17/50} | |
| tion | Irradiation | (mm) | (mm) | (kV) | (mA) | (μs) | (mm) | mm) | (mm) | (mm) | B₈(T) | (W/kg) | Remark |
| 1 | Erectron beam/ | 7 | 0.4 | 150 | 0.5 | 40 | 0.2 | 15.0 | 0.08 | 0.24 | 1.93 | 0.92 | Comparative |
| | Dotted line | | | | | | | | | | | | Example |
| 2 | Erectron beam/ | 3 | 0.1 | 150 | 0.8 | 40 | 0.2 | 24.0 | 0.12 | 0 | 1.92 | 0.9 | Comparative |
| | Dotted line | | | | | | | | | | | | Example |
| 3 | Erectron beam/ | 3 | 1.0 | 150 | 0.5 | 60 | 0.2 | 22.5 | 0.12 | 0.8 | 1.94 | 0.92 | Comparative |
| | Dotted line | | | | | | | | | | | | Example |
| 4 | Erectron beam/ | 3 | 0.5 | 150 | 3 | 100 | 0.2 | 225.0 | 0.55 | 0 | 1.92 | 0.9 | Comparative |
| | Dotted line | | | | | | | | | | | | Example |
| 5 | Erectron beam/ | 5 | 0.8 | 120 | 2.5 | 80 | 0.15 | 160.0 | 0.47 | 0.27 | 1.92 | 0.86 | Inventive |
| | Dotted line | | | | | | | | | | | | Example |
| 6 | Erectron beam/ | 5 | 0.5 | 40 | 1.5 | 100 | 0.15 | 40.0 | 0.19 | 0.3 | 1.94 | 0.85 | Inventive |
| | Dotted line | | | | | | | | | | | | Example |
| 7 | Erectron beam/ | 3 | 0.9 | 40 | 2.5 | 100 | 0.2 | 50.0 | 0.31 | 0.59 | 1.93 | 0.84 | Inventive |
| | Dotted line | | | | | | | | | | | | Example |
| 8 | Erectron beam/ | 3 | 0.4 | 80 | 2.5 | 40 | 0.15 | 53.3 | 0.23 | 0.12 | 1.92 | 0.86 | Inventive |
| | Dotted line | | | | | | | | | | | | Example |
| 9 | Erectron beam/ | 1.5 | 0.9 | 40 | 2.5 | 100 | 0.2 | 50.0 | 0.29 | 0.58 | 1.90 | 0.94 | Comparative |
| | Dotted line | | | | | | | | | | | | Example |
| 10 | Erectron beam/ | 11 | 0.9 | 40 | 2.5 | 100 | 0.2 | 50.0 | 0.33 | 0.55 | 1.94 | 0.90 | Comparative |
| | Dotted line | | | | | | | | | | | | Example |
| 11 | Erectron beam/ | 5 | 1.2 | 40 | 1.5 | 100 | 0.15 | 40.0 | 0.45 | 0.72 | 1.94 | 0.92 | Comparative |
| | Dotted line | | | | | | | | | | | | Example |
| 12 | Electron beam/ | 5 | — | 150 | 0.5 | Scanning | 0.2 | — | 0.14 | — | 1.92 | 0.91 | Comparative |
| | Continuous line | | | | | rate 5 m/s | | | | | | | Example |
| 13 | No irradiation | — | — | — | — | — | — | — | — | — | 1.94 | 1.05 | Comparative |
| | | | | | | | | | | | | | Example |

TABLE 3

| | | | | | | | | Strain-imparted area | | | | |
|---|---|---|---|---|---|---|---|---|---|---|---|---|
| | | | | | | | | | Interval | | | |
| | | Irradiation condition | | | | | | | between | | | |
| | | | | | Irradi- | | | Size of | adjacent | | Iron loss | |
| | | | | Average | ation | | | strain- | strain- | | of trans- | |
| | | Line | Dot | laser | period | Beam | E | imparted | imparted | | former | |
| | | interval | interval | power | per one | diameter | (mJ/ | area | areas | | W_{17/50} | |
| Condition | Irradiation | (mm) | (mm) | (W) | dot (μs) | (mm) | mm) | (mm) | (mm) | B₈(T) | (W/kg) | Remark |
| 1 | Continuous laser/ | 7 | 0.3 | 180 | 10 | 0.1 | 18.0 | 0.08 | 0.22 | 1.93 | 0.91 | Comparative |
| | Dotted line | | | | | | | | | | | Example |
| 2 | Continuous laser/ | 3 | 0.1 | 180 | 10 | 0.1 | 18.0 | 0.09 | 0 | 1.93 | 0.91 | Comparative |
| | Dotted line | | | | | | | | | | | Example |
| 3 | Continuous laser/ | 3 | 1.2 | 250 | 30 | 0.1 | 75.0 | 0.24 | 1.02 | 1.94 | 0.90 | Comparative |
| | Dotted line | | | | | | | | | | | Example |
| 4 | Continuous laser/ | 3 | 0.6 | 250 | 140 | 0.15 | 233.3 | 0.53 | 0.05 | 1.92 | 0.90 | Comparative |
| | Dotted line | | | | | | | | | | | Example |
| 5 | Continuous laser/ | 5 | 1.0 | 200 | 40 | 0.15 | 53.3 | 0.22 | 0.75 | 1.93 | 0.89 | Comparative |
| | Dotted line | | | | | | | | | | | Example |
| 6 | Continuous laser/ | 5 | 0.4 | 250 | 20 | 0.1 | 50.0 | 0.18 | 0.15 | 1.93 | 0.85 | Inventive |
| | Dotted line | | | | | | | | | | | Example |
| 7 | Continuous laser/ | 3 | 0.8 | 200 | 50 | 0.15 | 66.7 | 0.23 | 0.55 | 1.93 | 0.85 | Inventive |
| | Dotted line | | | | | | | | | | | Example |
| 8 | Continuous laser/ | 3 | 0.6 | 250 | 100 | 0.15 | 166.7 | 0.41 | 0.13 | 1.92 | 0.84 | Inventive |
| | Dotted line | | | | | | | | | | | Example |
| 9 | Continuous laser/ | 1.5 | 0.4 | 250 | 20 | 0.1 | 50.0 | 0.17 | 0.19 | 1.90 | 0.93 | Comparative |
| | Dotted line | | | | | | | | | | | Example |
| 10 | Continuous laser/ | 11 | 0.4 | 250 | 20 | 0.1 | 50.0 | 0.20 | 0.16 | 1.93 | 0.91 | Comparative |
| | Dotted line | | | | | | | | | | | Example |
| 11 | Continuous laser/ | 5 | — | 250 | Scanning | 0.15 | — | — | — | 1.93 | 0.90 | Comparative |
| | Continuous line | | | | rate 12 m/s | | | | | | | Example |
| 12 | No irradiation | — | — | — | — | — | — | — | — | 1.94 | 1.05 | Comparative |
| | | | | | | | | | | | | Example |

As shown in Tables 2 and 3, in our Examples where thermal strains were appropriately introduced by an electron beam or continuous laser beam at appropriate size of strain-imparted area and appropriate interval between the adjacent strain-imparted areas, the transformer iron loss decreased by 5% than Comparative Examples.

1. A grain oriented electrical steel sheet having thermal strain introduced thereinto in a dotted-line arrangement in which strain-imparted areas are lined in a direction that crosses a rolling direction of the steel sheet, wherein the strain-imparted areas introduced in the dotted-line arrangement have a size from 0.10 mm or more to 0.50 mm or less and an interval between the adjacent strain-imparted areas is from 0.10 mm or more to 0.60 mm or less.

2. The grain oriented electrical steel sheet of claim 1, wherein a line interval between the dotted-lines in the rolling direction is 2 mm to 10 mm.

3. A method for manufacturing a grain oriented electrical steel sheet, comprising:
introducing thermal strain into a grain oriented electrical steel sheet in a dotted-line arrangement in which strain-imparted areas have been lined in a direction that crosses a rolling direction of the steel sheet by irradiating with an electron beam, wherein a line interval between the electron beam irradiation in the rolling direction is 2 mm to 10 mm, an irradiated dot interval in the dotted-line arrangement is 0.2 mm or more to 1. 0 mm or less, and an irradiation energy amount E per unit beam diameter defined by Formula (1) is 30 mJ/mm or more and 180 mJ/mm or less, wherein:
E=[Acceleration voltage of electron beam (kV)×Beam current value (mA)×Irradiation period per one dot (μs)/1 000]/Beam diameter (mm) (1).

4. A method for manufacturing a grain oriented electrical steel sheet comprising:
introducing a thermal strain into a grain oriented electrical steel sheet in a dotted-line arrangement in which strain-imparted areas are lined in a direction that crosses a rolling direction of the steel sheet by continuously irradiating with a laser beam, wherein a line interval between the continuous laser irradiation in the rolling direction is 2 mm to 10 mm, an irradiated dot interval in the dotted-line arrangement is 0.2 mm or more to 1.0 mm or less, and an irradiation energy amount E per unit beam diameter defined by Formula (2) is 40 mJ/mm or more and 200 or less, wherein:
E×[Average laser power (W)×Irradiation period per one dot (μs)/1000]/Beam diameter (mm) (2).
